(19) United States
(12) Patent Application Publication
(10) Pub. No.: US 2025/0028653 A1
(43) Pub. Date: Jan. 23, 2025

(54) MEMORY PROGRAM SECURIZATION METHOD

(71) Applicant: STMicroelectronics International N.V., Geneva (CH)

(72) Inventor: Jawad BENHAMMADI, Pont de Claix (FR)

(73) Assignee: STMicroelectronics International N.V., Geneva (CH)

(21) Appl. No.: 18/776,561

(22) Filed: Jul. 18, 2024

(30) Foreign Application Priority Data
Jul. 20, 2023 (FR) 2307762

(51) Int. Cl. G06F 12/14; G06F 21/57

(52) U.S. Cl. CPC G06F 12/1441; G06F 12/1458; G06F 21/575

(57) ABSTRACT

A method of securization of programs in a memory embedded within a microcontroller includes writing a boot program into a first area of the memory and writing at least one additional program into at least one second area of the memory. One or more values of a first register are modified to provide a write protection of the first and second areas. A prohibition against modification of the one or more values of the first register is then implemented when those values are associated with a write protection state of the first area.

### PRIORITY CLAIM

This application claims the priority benefit of French Application for Patent No. 2307762, filed on Jul. 20, 2023, the content of which is hereby incorporated by reference in its entirety to the maximum extent allowable by law.

### TECHNICAL FIELD

The present disclosure generally concerns methods of securization (e.g., providing security protection) of programs in memories, as well as to devices implementing these methods.

### BACKGROUND

Many electronic circuits, such as microcontrollers, use a boot program (BOOT) which is loaded into a non-volatile memory of the circuit at circuit booting to then run a boot application. Other programs may also then be loaded to run other applications. For security reasons, areas of the memory having the boot program, the other programs, or simply data loaded therein must be able to be made write-protected (i.e., secured) with respect to the outside of the circuit and/or with respect to other applications. Current solutions are unable to guarantee both an optimum security during the successive loadings of the boot program and of the other programs, and a flexibility in defining memory areas to be write-protected.

There is a need to ensure both an optimum security during loading of the boot program and of the other programs and to obtain a flexibility in defining the memory areas to be write-protected.

There is a need in the art to overcome all or part of the disadvantages of known methods.

### SUMMARY

An embodiment provides a method of securization of programs in a memory, comprising: writing a boot program into a first area of said memory; writing at least one additional program into at least one second area of said memory; modifying one or a plurality of values of a first register to provide a write protection of the first and second areas; and prohibiting modification of said one or a plurality of values of the first register when they are associated with a write protection state of the first area.

In an embodiment, said first register associates a write protection state value with one or a plurality of areas of said memory.

In an embodiment, wherein prohibiting modification comprises modifying a value of a second register.

In an embodiment, the modification of the value of the second register is authorized according to a state of the circuit comprising said memory.

In an embodiment, the state of the circuit comprising said memory is a state from among a regression state, a state open to writing, and a provisioning state.

In an embodiment, the modification of the value of the second register is authorized by the use of a specific security code.

In an embodiment, the second register is configured to take two distinct values each coded over a number of bits greater than or equal to 8, each bit of one of the two distinct values being different from the corresponding bit of the other value.

In an embodiment, the second register is non-volatile.

In an embodiment, the first register is non-volatile.

In an embodiment, the prohibition to modify said one or a plurality of values of the first register is implemented after the writing of said at least one additional program.

In an embodiment, the prohibition to modify said one or a plurality of values of the first register is implemented prior to the writing of said at least one additional program.

In an embodiment, the first area of said memory is defined by two user option bytes.

In an embodiment, the write protection of said boot program is implemented prior to the writing of said at least one additional program.

An embodiment provides a microcontroller, comprising a memory, and configured to implement the above-described program securization method, in this memory.

In an embodiment, said memory is non-volatile.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 very schematically shows in the form of blocks an example of an integrated circuit of the type to which the described embodiments apply;

FIG. 2 schematically shows an example of a memory of the integrated circuit of FIG. 1;

FIG. 3 schematically illustrates steps of a method of in-memory securization of programs according to an embodiment;

FIG. 4 illustrates an implementation mode of a method of in-memory securization of programs; and

FIG. 5 illustrates another implementation mode of a method of in-memory securization of programs.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

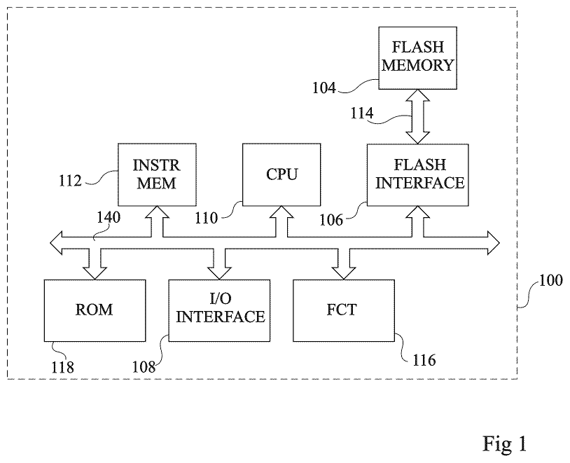

FIG. 1 very schematically shows in the form of blocks an example of an integrated circuit 100 of the type to which the described embodiments apply. Circuit 100 is, for example, a microcontroller.

Circuit 100 comprises a non-volatile memory 104 (FLASH MEMORY), for example of FLASH memory type (for example, an embedded memory of the microcontroller), capable of communicating, over a communication bus 114, with a non-volatile memory interface 106 (FLASH INTERFACE) configured to write or read data into and from non-volatile memory 104.

Circuit 100 further comprises, for example, a processing unit 110 (CPU) comprising one or a plurality of processors under control of instructions stored in an instruction memory 112 (INSTR MEM). Instruction memory 112 is, for example, a volatile random-access memory (RAM). Processing unit 110 and memory 112 communicate, for example, over a system (data, address, and control) bus 140. FLASH memory 104 is coupled to system bus 140 via non-volatile memory interface 106 and via bus 114. Device 100 further comprises an input/output interface 108 (I/O interface) coupled to system bus 140 to communicate with the outside.

Device 100 may incorporate other circuits implementing other functions (for example, one or a plurality of volatile and/or non-volatile memories, or other processing units), symbolized by a block 116 (FCT) in FIG. 1. Among these other circuits, circuit 100 comprises, for example, a read-only or static memory 118 (ROM).

The described methods concern the securization of programs or data loaded into non-volatile memory 104.

For this purpose, the boot programs are, for example, directly transferred to memory 104 during in-factory programming processes. However, the content of a flash memory can in principle be modified. Now, it must be ascertained, for example in the case of the loading of a plurality of operating systems, that they cannot be modified once transferred into flash memory 104, unless there is a regression of system or circuit 100.

An example concerns BOOT programs and OEM operating systems or applications, which have to be loaded during the manufacturing processes of circuit 100, for example by a plurality of different successive subcontractors or users. For example, circuit 100 is, as it leaves the factory, in state called “open”, that is, the memory is not write-protected. Then a first subcontractor has the task of loading a boot program (iROT for Immutable Root Of Trust) into memory 104, the circuit then is in a provisioning mode. Once loaded and secured, circuit 100 switches to the iROT provisioned mode. At this stage, the iROT boot program can take charge of the other installation steps comprising code and encryption keys, for example. Another subcontractor may then load one or a plurality of programs such as, for example, one or a plurality of operating system and/or secure applications and/or updates, which, once loaded, have to be secured. At this stage, the product enters a closed mode. At this stage, the different installed programs can take charge of the non-secure installations comprising code and encryption keys. Non-secure applications can then be installed.

The boot programs are implemented at the system initialization in flash memory 104, so that they can then be executed at each booting of the system. However, once in the flash memory, the access to the boot program must be protected from other boot programs, from any application, or from an access from the outside of the circuit, to prevent it from being modified. To achieve this, a write protection of the area of memory 104 containing the boot program is provided, so that it cannot be accessed unless the circuit is rebooted. A write protection of certain areas (comprising one or a plurality of sectors) of memory 104 linked to the other programs or data is also provided.

Once write-protected, it is currently difficult to enable to keep a flexibility as to possible subsequent modifications of the memory areas to be protected, while guaranteeing the immutability of the iROT boot program.

The described embodiments provide a method of in-memory securization of programs, comprising a writing of the iROT boot program into a first area of said memory; a writing of at least one additional program (uROT (updated Root of Trust), Secure operating system (OS), Applications) into at least one second area of said memory; a write protection of the first and second areas by modifying one or a plurality of values of a first register (WRPSG1/2); and a prohibition to modify said one or a plurality of values of the first register WRPSG1/2 when they are associated with a write protection state of the first area.

The write-protected areas are thus flexibly and easily defined, for example by means of a single register. The immutability of the iROT boot program is ensured due to the prohibition to modify the write protection targeted on memories dedicated to the iROT boot program. It is possible to use the write protection during all the product manufacturing phases, for example by different subcontractors, from a phase when the circuit is in the open state to a phase when it is in the closed state. A plurality of program layers can thus define their own memory zones to be write-protected for their own programs.

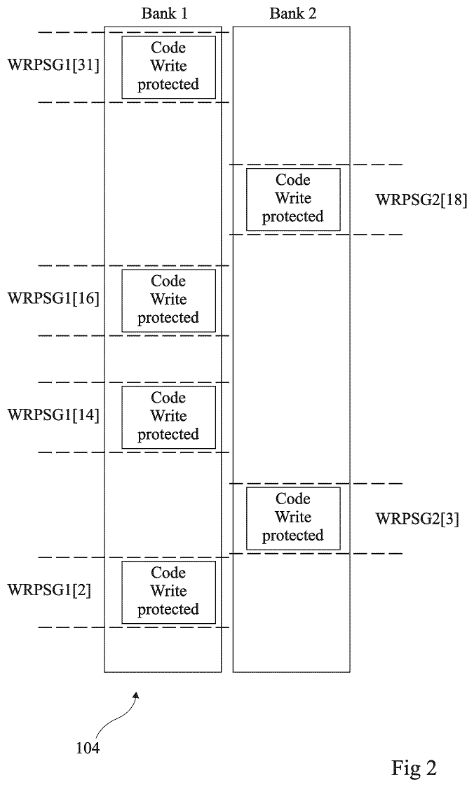

FIG. 2 schematically shows an example of a memory 104 of the integrated circuit of FIG. 1. More specifically, in the example of FIG. 2, the memory comprises two memory banks (Bank 1, Bank 2). In this example, groups of memory sectors numbered 2, 3, 14, 16, 18, and 31 are write-protected by the use of first register WRPSG1/2, which uses a bitmap associating a write protection state value (for example 0 for “non-protected” and 1 for “protected”) with one or a plurality of areas of said memory. In the shown example, register WRPSG1/2 takes values WRPSG1[2]=1, WRPSG1[14]=1, WRPSG1[16]=1, and WRPSG1[31]=1 to write protect the groups of sectors numbered 2, 14, 16, and 31 in the first bank. The other sectors in the first bank are at state 0 in the first bank of the register, that is, for example, WRPSG1[X]=0 where X represents the numbers of groups of non-protected sectors of the first bank. A same line of reasoning applies to the second bank, with register WRPSG1/2 taking values WRPSG2[3]=1 and WRPSG2[18]=1 to write protect the groups of sectors numbered 3 and 18 in the second bank.

Each program which is loaded into the circuit when it is in the “open” and “provisioning” states, and before the state is “closed”, can thus flexibly define sectors, or areas, of memory 104 which are write-protected by modifying the 0 or 1 value associated with these sectors in register WRPSG1/2.

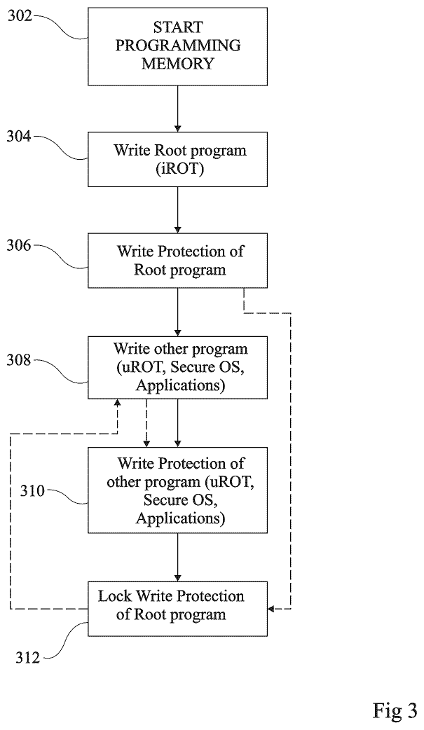

FIG. 3 schematically illustrates steps of a method of in-memory securization of programs according to an embodiment.

At a step 302 (START PROGRAMMING MEMORY), the program securization method begins.

At a step 304 (Write Root program (iROT)), the iROT boot program is loaded into a first area or areas of memory 104. In an example, the first area of memory 104 is defined by two user option bytes (HDP_START, HDP_END). These two user option bytes are, for example, non-volatile.

At a step 306 (Write Protection of Root program), subsequent to step 304, the first area, which corresponds to the iROT boot program, is write-protected by modifying the write protection state (from 0 to 1) of the WRPSG1/2 register corresponding to the first area.

At a step 308 (Write other program (uROT, Secure OS, Applications)), other programs such as other boot programs (uROT), one or a plurality of operating systems (Secure OS) or also one or a plurality of applications are loaded into at least one second area of memory 104.

At step 310 (Write Protection of other program (uROT, Secure OS, Applications), the second area is write-protected by changing the write protection state (from 0 to 1) of the register WRPSG1/2 corresponding to the second area.

At a step 312 (Lock Write Protection of Root program), the modification of the values of register WRPSG1/2 which are associated with the write protection state of the first area is prohibited. This prohibition comprises, for example, the modification of a value of a second register (WRPLOCK). In an example, the value of the second register switches to 1 to enable the prohibition to modify the values of the first register values associated with the first area. In other words, when the value of second register WRPLOCK switches to 1, the modification of the values of register WRPSG1/2 associated with the first area is prohibited. Only a regression state of the circuit for example enables to modify the second register.

In an example, the value of the second register WRPLOCK is only modifiable by a restricted-access secure and privilege program (SW).

In another example, the value of the second register WRPLOCK is a non-volatile resource defined, for example, by a user option byte. This allows register WRPLOCK to be usable as soon as processing unit 110 is switched on.

Second register WRPLOCK may, for example, be modified when the circuit is in the “open” state or until the provisioning state.

In an example (illustrated by dashed arrows), steps 306, 312, 308, and 310 are successively carried out.

In another example (illustrated by full arrows), steps 306, 308, 310 and 312 are successively carried out.

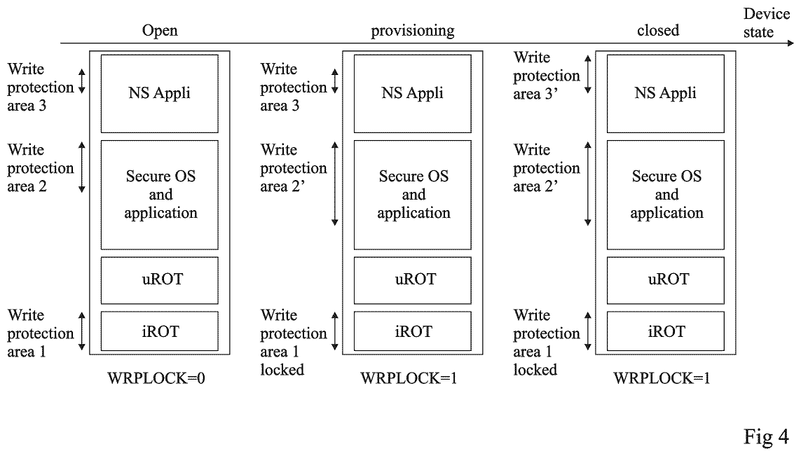

FIG. 4 illustrates a method of in-memory securization of programs. More particularly, FIG. 4 describes memory 104 in different open, provisioning, and closed states of the circuit (Device state), for example corresponding to manufacturing phases for example by different subcontractors.

In the illustrated example, the circuit is first in the “open” state. In this state, the iROT boot program is loaded into the first memory area, for example, and is write-protected (Write protection area 1). A monotonic counter HDPL1 is, for example, used to define the protection area of the iROT program with a user option byte OB-HDP. A second boot program (uROT) is then loaded into the memory in another area, without being write-protected. An operating system and/or other applications (Secure OS and application) are also loaded into another area of memory 104 and then only certain sectors of memory linked to these programs are write-protected (Write protection area 2). Less secure applications (NS Appli) are also loaded into still another area of memory 104, and then only certain memory sectors linked to these applications are write-protected (Write protection area 3). In this state, the value of register WRPLOCK is 0, which implies that the modification of the write protection values of register WRPSG1/2, associated with the memory area into which the iROT program is loaded, is not prohibited.

Then, the circuit is in the provisioning state. In this state, the value of register WRPLOCK is 1, which means that change of the write protection values of register WRPSG1/2, associated with the memory area into which the iROT program is loaded, is prohibited (Write protection area 1 locked). However, the change of the write protection values of register WRPSG1/2, associated with other areas of memory 104 which are different from the memory area into which the iROT program is loaded, remains possible. In the shown example, the write protection value(s) of register WRPSG1/2 which are associated with the operating system and/or other applications (Secure OS and application) are modified (Write protection area 2′) to increase the number of write-protected sectors.

Then, the circuit is set to the “closed” state. The write protection value(s) of register WRPSG1/2 which are associated with the less secure applications (NS Appli) are modified to increase and change the number of write-protected sectors (Write protection area 3′).

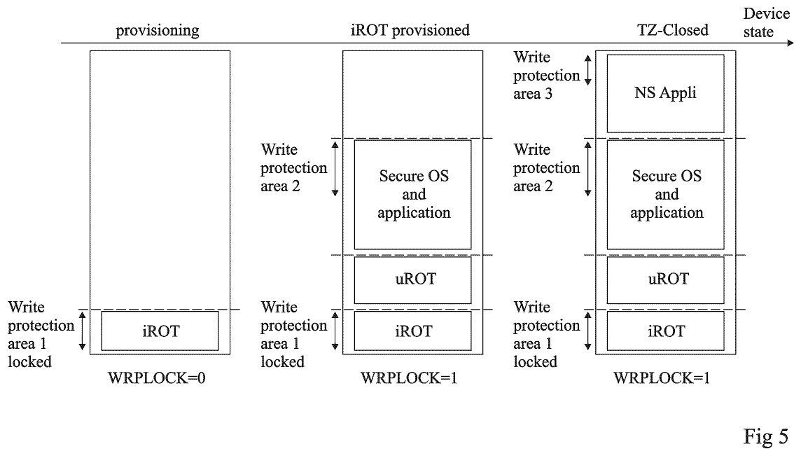

FIG. 5 illustrates another implementation mode of an in-memory securization method.

In particular, FIG. 5 describes memory 104 in different states of the circuit (Device state), provisioning, iROT provisioned, and TZ-Closed.

In the illustrated example, the circuit is first in the “provisioning” state. In this state, the iROT boot program is loaded into the first memory area, for example, and is write-protected (Write protection area 1). The value of register WRPLOCK is set to 1 (Write protection area 1 locked) after the write protection.

In the illustrated example, the circuit then is in the “iROT provisioned” state. In this state, a second boot program (uROT) is then loaded into the memory in another area, without being specifically write-protected. An operating system and/or other applications (Secure OS and application) are also loaded into still another area of memory 104. Only certain sectors of the memory linked to this operating system and/or other applications are then write-protected (Write protection area 2) by the modification of values of register WRPSG1/2. The value of register WRPLOCK remains locked at 1. In the illustrated example, the circuit is then in the closed state (TZ-Closed). Less secure applications (NS Appli) are loaded into still another area of memory 104, and then only certain sectors of the memory linked to these applications are write-protected (Write protection area 3). The value of register WRPLOCK remains locked at 1.

The examples of FIGS. 4 and 5 enable to keep flexibility to modify the memory areas which are write-protected while ensuring that the change of the write-protected values associated with the iROT boot program memory area is prohibited once the value of register WRPLOCK has switched to 1.

Various embodiments and variants have been described. Those skilled in the art will understand that certain features of these various embodiments and variants may be combined, and other variants will occur to those skilled in the art. In particular, although in the disclosed examples the modification of register WRPLOCK to state 1 activates the modification prohibition, those in the art will be capable of implementing the opposite, that is, the value of WRPLOCK at 0 triggers the modification prohibition. Further, register WRPLOCK may be used, for example, to prohibit the modification of WRPSG1/2 over only part of the sectors associated with the iROT program.

Finally, the practical implementation of the described embodiments and variants is within the abilities of those skilled in the art based on the functional indications given hereabove. In particular, in the shown examples, only one register WRPLOCK is used to prohibit modifications to the values corresponding to sectors of a single iROT boot program. Those in the art may however implement a plurality of additional registers having a function similar to that of register WRPLOCK. These additional registers may be used, like register WRPLOCK, to prohibit the modification of certain values of register WRPSG1/2 which are associated with areas of memory 104 corresponding to other programs, applications or data, different from the iROT boot program, and which must be immutably write-protected.

1. A method of securization of programs in a memory of a microcontroller, comprising:
writing a boot program into a first area of said memory;
writing at least one additional program into at least one second area of said memory;
modifying one or a plurality of values of a first register to provide a write protection of the first and second areas; and
prohibiting modification of said one or a plurality of values of the first register when said one or a plurality of values are associated with a write protection state of the first area.

2. The method according to claim 1, wherein said first register associates a write protection state value with one or a plurality of areas of said memory.

3. The method according to claim 1, wherein prohibiting modification comprises a modification of a value of a second register.

4. The method according to claim 3, wherein the modification of the value of the second register is authorized according to a state of the microcontroller comprising said memory.

5. The method according to claim 4, wherein the state of the microcontroller comprising said memory is a state selected from among a regression state, a state open to writing, and a provisioning state.

6. The method according to claim 3, wherein the modification of the value of the second register is authorized by the use of a specific security code.

7. The method according to claim 6, wherein the second register is configured to take two distinct values each coded over a number of bits greater than or equal to 8, each bit of one of the two distinct values being different from the corresponding bit of the other value.

8. The method according to claim 7, wherein the second register is non-volatile.

9. The method according to claim 8, wherein the first register is non-volatile.

10. The method according to claim 1, wherein prohibiting modification of said one or a plurality of values of the first register is implemented after writing said at least one additional program into the at least one second area of said memory.

11. The method according to claim 1, wherein prohibiting modification of said one or a plurality of values of the first register is implemented prior to writing said at least one additional program into the at least one second area of said memory.

12. The method according to claim 1, wherein the first area of said memory is defined by two user option bytes.

13. The method according to claim 1, wherein the write protection of said boot program is implemented prior to the writing of said at least one additional program.

14. A microcontroller comprising a memory and configured to implement the program securization method according to claim 1 in said memory.

15. The microcontroller according to claim 14, wherein said memory is non-volatile.
